(19) United States
(12) Patent Application Publication
(10) Pub. No.: US 2024/0308829 A1
(43) Pub. Date: Sep. 19, 2024

(54) RETENTION SYSTEM FOR SPRING-LOADED LIFT

(71) Applicant: GLOBAL INDUSTRIAL DISTRIBUTION INC., Port Washington, NY (US)

(72) Inventors: Bruce B. ZUTLER, Port Washington, NY (US); Kevin CHOW, Port Washington, NY (US)

(73) Assignee: GLOBAL INDUSTRIAL DISTRIBUTION INC., Port Washington, NY (US)

(21) Appl. No.: 18/606,444

(22) Filed: Mar. 15, 2024

Related U.S. Application Data
(60) Provisional application No. 63/452,314, filed on Mar. 15, 2023.

(51) Int. Cl. B66F 11/04

(52) U.S. Cl. CPC B66F 11/04

(57) ABSTRACT

A method of compressing a spring-loaded lift is disclosed. The method may include providing a coupling having a first locking element, a second locking element, and a fastener, wherein a first end of the fastener is configured to engage with the first locking element, and wherein a second end of the fastener is configured to engage with the second locking element. The method may include engaging the first locking element with a first frame of a spring-loaded lift, engaging the second locking element to a second frame of the spring-loaded lift, engaging the first end of the fastener with the first locking element, engaging the second end of the fastener with the second locking element, and actuating the fastener thereby moving the first and second frames of the spring-loaded lift closer to one another.

### CROSS-REFERENCE TO RELATED APPLICATION

This application claims priority to U.S. Provisional Patent Application No. 63/452,314 filed Mar. 15, 2023, the contents of which is incorporated herein by reference in its entirety.

### FIELD

The present invention relates to a retention system for a spring-loaded lift.

### BACKGROUND

Spring-loaded lifts are typically transported or shipped in their expanded or most de-compressed configuration due to the strength of the incorporated spring. That is, to ensure the spring constant, or performance of the spring, is not impacted (e.g., through unnecessary compression or wear), spring-loaded lifts tend to be transported or shipped such that the spring is in a fully extended configuration. In addition, transporting or shipping spring-loaded lifts in a fully expanded configuration is typically done to reduce risk of injury to personnel, as if the spring was compressed (e.g., using bars or ratchet straps), operators or individuals handling the devices could be injured upon quick or sudden release of the spring.

In view of how large and cumbersome spring-loaded lifts can be to ship or transport, and the potential risk of operator injury, a need exists for an improved spring-loaded lift retention system. Embodiments of the present disclosure are directed to this and other considerations.

### SUMMARY

A method of compressing a spring-loaded lift is disclosed. The method may include providing a coupling having a first locking element, a second locking element, and a fastener, wherein a first end of the fastener is configured to engage with the first locking element, and

wherein a second end of the fastener is configured to engage with the second locking element. The method may include engaging the first locking element with a first frame of a spring-loaded lift. The method may include engaging the second locking element to a second frame of the spring-loaded lift. The method may include engaging the first end of the fastener with the first locking element. The method may include engaging the second end of the fastener with the second locking element. The method may include actuating the fastener thereby moving the first and second frames of the spring-loaded lift closer to one another.

A method of compressing a spring-loaded lift is disclosed. The method may include removably engaging a first bracket with a first frame of a spring-loaded lift. The method may include removably engaging a second bracket with a second frame of the spring-loaded lift. The method may include engaging a first locking element of a coupling with the first bracket. The method may include engaging a second locking element of the coupling with the second bracket. The method may include engaging a first end of a fastener of the coupling with the first locking element. The method may include engaging a second end of the fastener of the coupling with the second locking element. The method may include actuating the fastener of the coupling thereby moving the first and second frames of the spring-loaded lift closer to one another.

A spring-loaded lift is disclosed. The spring-loaded lift may include a first frame having a first receptacle, a second frame having a second receptacle, and a coupling having a first locking element, a second locking element, and a fastener. The first locking element may be configured to engage with the first frame via the first receptacle. The second locking element may be configured to engage with the second frame via the second receptacle. A first end of the fastener may be configured to engage with the first locking element. A second end of the fastener may be configured to engage with the second locking element. Actuating the fastener may thereby move the first and second frames of the spring-loaded lift closer to one another.

A retention system for spring-loaded lift is enclosed. The system may include a U-boat utility cart having a platform. The system may include a spring-loaded lift having a bottom frame configured to removably engage with the platform, a first frame having a first receptacle, and a second frame having a second receptacle. The system may include a coupling having a first locking element, a second locking element, and a fastener. The first locking element may be configured to engage with the first frame via the first receptacle. The second locking element may be configured to engage with the second frame via the second receptacle. A first end of the fastener may be configured to engage with the first locking element. A second end of the fastener may be configured to engage with the second locking element. Actuating the fastener may thereby move the first and second frames of the spring-loaded lift closer to one another.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a perspective view of a retention system for a spring-loaded lift, according to certain embodiments of the present disclosure.

FIG. 2 is a perspective view of a spring-loaded lift from FIG. 1, the spring-loaded lift being in a compressed state, according to certain embodiments of the present disclosure.

FIG. 3 illustrates one or more components of the retention system of FIG. 1, according to certain embodiments of the present disclosure.

FIG. 4 illustrates one or more components of the retention system of FIG. 1, according to certain embodiments of the present disclosure.

FIGS. 5A-5C illustrate one or more components of the retention system of FIG. 1, according to certain embodiments of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified.

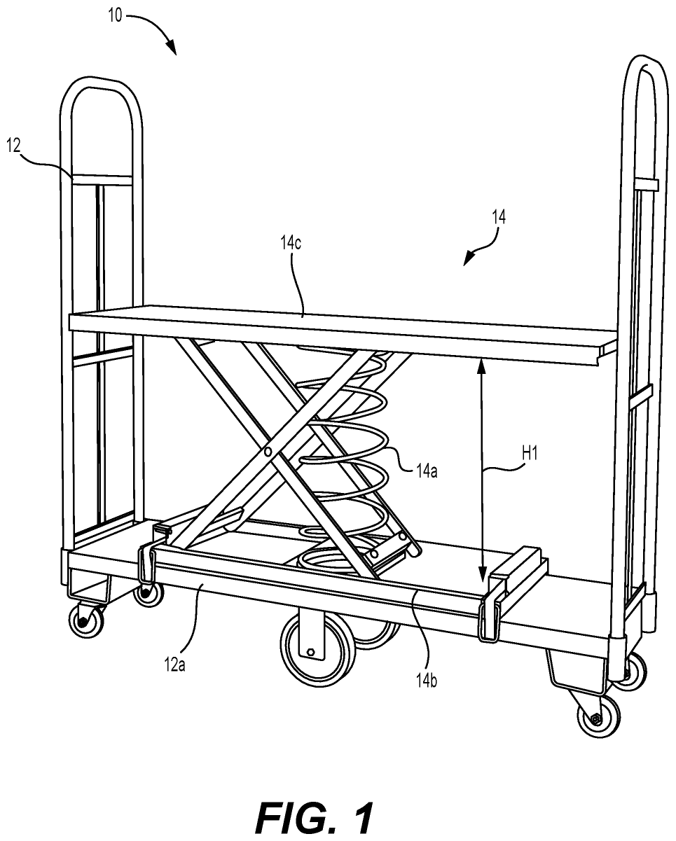

Reference will now be made in detail to exemplary embodiments of the disclosed technology, examples of which are illustrated in FIGS. 1, 2, 3, 4, and 5A-5C, and disclosed herein. Wherever convenient, the same reference numbers will be used throughout the drawings to refer to the same or like parts.

FIG. 1 depicts an embodiment of a system 10 used for retention of a spring-loaded lift 14. In some embodiments, the system 10 may include a U-boat utility cart 12 having a platform 12a. One of ordinary skill in the art will appreciate that system 10 may include any type of utility cart or truck configured for carrying and/or transporting goods, such as in a warehouse.

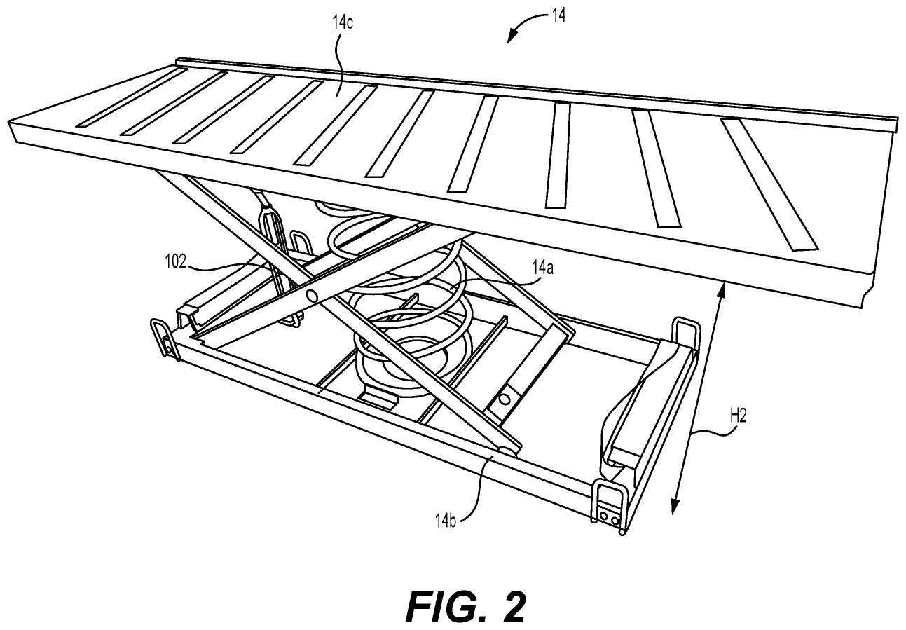

In some embodiments, system 10 may include a spring-loaded lift 14 that may include a spring 14a, a bottom frame 14b, and a top surface 14c. Spring-loaded lift 14 may be configured such that as items (e.g., boxes of goods, products, etc.) are placed on the top surface 14c, the spring 14a may be compressed and the top surface 14c may be incrementally moved downward under the weight of the items. As the items are removed from the top surface 14c, the spring 14a may be incrementally released or de-compressed, such that the top surface 14c moves upward as the weight of the items is reduced. FIG. 1 illustrates spring-loaded lift 14 in its expanded or de-compressed configuration, having decompressed height H1, while FIG. 2 illustrates spring-loaded lift 14 in its compressed configuration, having compressed height H2. Compressed height H2 is always less than decompressed height H1 and, as discussed further below, H2 may be approximately 6 to 10 inches shorter than H1.

In some embodiments, the spring-loaded lift 14 may be configured to removably engage with or attach to the U-boat utility cart 12 (or other type of cart) via, for example, the bottom frame 14b of the spring-loaded lift 14. Attaching the spring-loaded lift 14 to the U-boat utility cart 12 may provide a benefit of more easily being able to move, load, and unload items, such as in a warehouse or other facility.

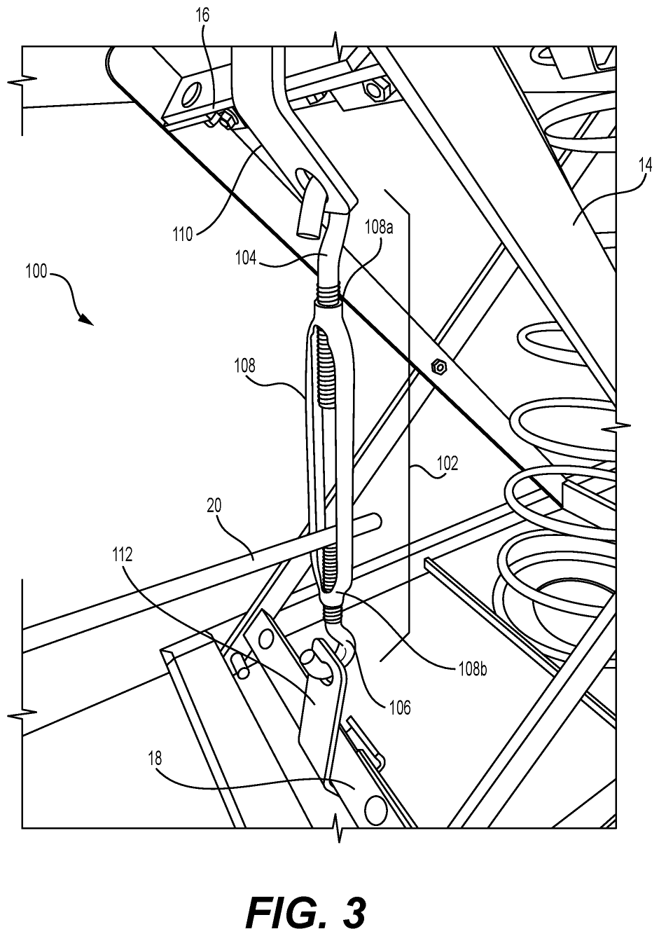

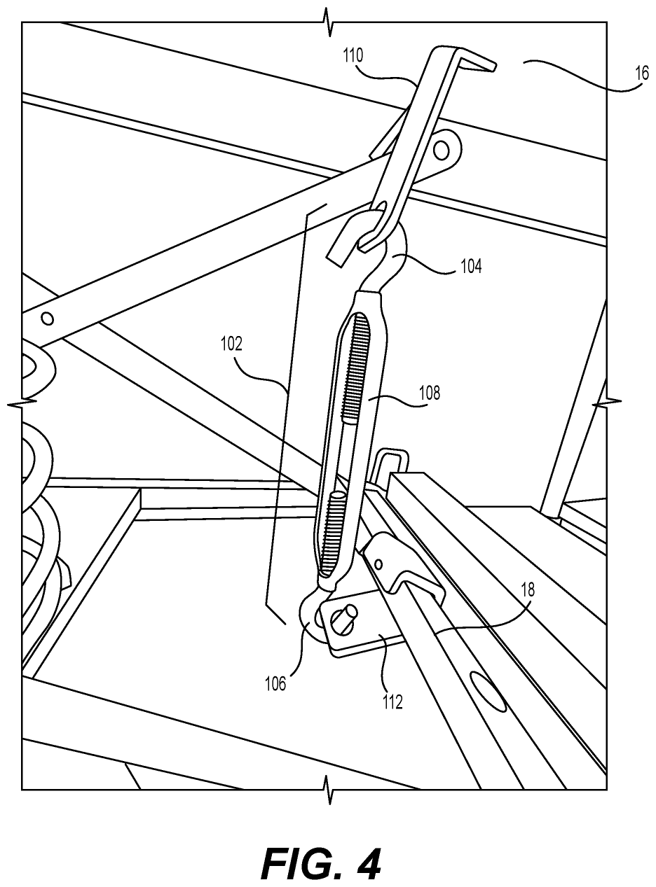

FIGS. 3 and 4 illustrate additional components that may be included in system 10. In some embodiments, system 10 may include a coupling 102 that itself may include a first locking element 104, a second locking element 106, and a fastener 108. As discussed herein, the coupling 102 may be a type of mechanism, such as a turnbuckle, configured to aid in incrementally compressing, and thus reducing the overall volume of, the spring-loaded lift 14, such as during transport or shipment.

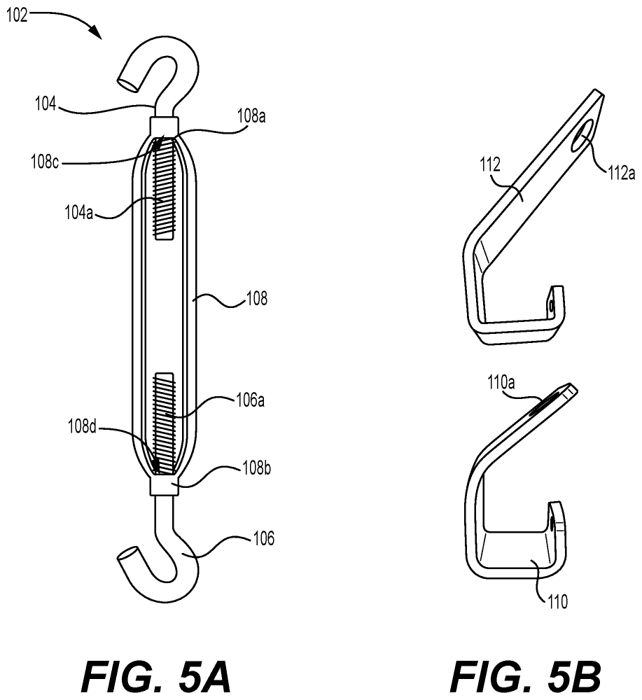

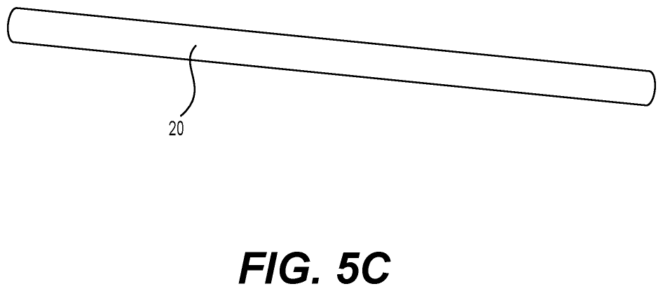

In some embodiments, the first locking element 104, e.g., a hook, may be configured to engage with a first frame 16 of the spring-loaded lift 14. In some embodiments, the first locking element 104 may be directly attached to the first frame 16, such as via a receptacle (e.g., a hole or other receiving mechanism) of the first frame 16, and/or a chain link welded to the first frame 16 or passed through the receptacle. In some embodiments, the first locking element 104 may instead be configured to removably engage with a first bracket 110 that may itself be configured to removably engage with the first frame 16. As particularly shown in FIG. 5B, first bracket 110 may be configured in any shape or size necessary to removably engage with the first frame 16 of the spring-loaded lift 14 and the first locking element 104. For example, the first bracket 110 may have a hook-like shape such that the first bracket 110 may be hooked around the first frame 16 (and/or engaged with the first frame 16 via a fastener, such as a screw, nut, bolt, etc. or hooked through the receptacle). The first bracket 110 may further have an opening 110a (e.g., a hole) configured to receive the first locking element 104.

In some embodiments, the second locking element 106, e.g., a hook, may be configured to engage with a second frame 18 of the spring-loaded lift 14. In some embodiments, the second locking element 106 may be directly attached to the second frame 18, such as via a receptacle (e.g., a hole or other receiving mechanism) of the second frame 18, and/or a chain link welded to the second frame 18. In some embodiments, the second locking element 106 may instead be configured to removably engage with a second bracket 112 that may itself be configured to removably engage with the second frame 18. As particularly shown in FIG. 5B, second bracket 112 may be configured in any shape or size necessary to removably engage with the second frame 18 of the spring-loaded lift 14 and the second locking element 106. For example, the second bracket 112 may have a hook-like shape such that the second bracket 112 may be hooked around the second frame 18 (and/or engaged with the second frame 18 via a fastener, such as a screw, nut, bolt, etc.). The second bracket 112 may further have an opening 112a (e.g., a hole) configured to receive the second locking element 106.

The means by which the locking elements 104, 106 and/or the brackets 110, 112 engage with their respective parts of the frame 16, 18 can be any of the examples and can be the same or different type or any combination thereof. For example, the first locking element 104 can removable engage directly to the first frame 16 while the second locking element 106 engages with the second bracket 112 via the opening 112a and the second bracket 112 engages with the second frame 18.

In some embodiments, as particularly shown in FIGS. 3, 4, and 5A, the fastener 108 may include a first end 108a and a second end 108b that each may include a respective threaded female connector 108c, 108d configured to receive a respective threaded male connector 104a, 106a of the first and second locking elements 104, 106. In this way, the coupling 102 may be configured such that the first and second locking elements 104, 106 may respectively rotatably engage with the first and second ends 108a, 108b of the fastener 108.

In some embodiments, the respective threaded male connector 104a of the first locking element 104 may include a right-hand thread (or left-hand thread), while the respective threaded male connector 106a of the second locking element 106 may include a left-hand thread (or right-hand thread). In some embodiments, the coupling 102 may be configured like a turnbuckle.

In some embodiments, actuating the fastener 108, such as by rotating the fastener 108 in a first direction (e.g., clockwise) with a turning rod 20 (FIGS. 3 and 5C), may move the first and second frames 16, 18 of the spring-loaded lift 14 closer to one another (e.g., between approximately 6 to 10 inches), and may incrementally compress the spring 14a (e.g., by approximately 6 to 10 inches). These actions of moving the first and second frames 16, 18, and compressing the spring 14a, may be configured to occur gradually or incrementally. In some embodiments, de-actuating the fastener 108, such as by rotating the fastener 108 in a second direction (e.g., counterclockwise), may move the first and second frames 16, 18 away from one another, and may incrementally release the spring 14a. These incremental movements and adjustments provide a safety benefit of being able to compress and de-compress the spring without a sudden expansion of the spring 14a. This allows for the decreasing and increasing of the volume of the overall spring-loaded lift 14, without a risk of injuring a person who may be operating the lift or working nearby. For example, if the spring 14a de-compresses too quickly it can result in the upper surface 14c of the spring-loaded lift 14 rising quickly or suddenly and impacting an unaware user. Other systems that allow for the incremental release of the spring 14a are also contemplated by the invention.

It should be understood that the coupling 102 may be configured for placement at a variety of positions on the spring-loaded lift 14. For example, the coupling 102 may be configured to removably engage with the spring-loaded lift 14 at the center of and/or to one side of the first and second frames 16, 18.

It is further understood that in one example, it is the incremental movements of the fastener 108 that provide a safety and efficiency benefit. It is the incremental compression of the spring 14a that typically allows for a magnification of force to allow a single user to compress the spring 14a without loading/pre-loading the top surface 14c or frames 16, 18 to act against the spring force. It is the incremental de-compression of the spring 14a that adds the safety feature and the ability to adjust the height of top surface 14c so the spring is not released suddenly.

In some embodiments, system 10 may be configured such that coupling 102 (e.g., one or more of first locking element 104, second locking element 106, fastener 108), first and second brackets 110, 112, and/or turning rod 20 may be configured to removably engage with U-boat utility cart 12 and/or spring-loaded lift 14, for example, during transport and/or storage. For example, coupling 102, first and second brackets 110, 112, and/or turning rod 20 may be configured such that upon de-compressing spring 14a and/or spring-loaded lift 14a (e.g., after transporting or shipping spring-loaded lift 14a), coupling 102, first and second brackets 110, 112, and/or turning rod 20 may affix to a side of or underneath U-boat utility cart 12 and/or spring-loaded lift 14 for storage. As part of this storage configuration, at least one of the first locking element 104, the second locking element 106, and the fastener 108 of the coupling 102 can be stored together or as separate elements. A benefit of this feature is that coupling 102, first and second brackets 110, 112, and/or turning rod 20 need not be discarded after a single use, but may instead be reused for compressing and de-compressing spring 14a, and thus modifying the overall volume of spring-loaded lift 14.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±20% of the recited value, e.g., “about 90%” may refer to the range of values from 71% to 99%.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method of compressing a spring-loaded lift, the method comprising:
providing a coupling comprising a first locking element, a second locking element, and a fastener,
wherein a first end of the fastener is configured to engage with the first locking element, and
wherein a second end of the fastener is configured to engage with the second locking element;
engaging the first locking element with a first frame of a spring-loaded lift;
engaging the second locking element to a second frame of the spring-loaded lift;
engaging the first end of the fastener with the first locking element;
engaging the second end of the fastener with the second locking element; and
actuating the fastener thereby moving the first and second frames of the spring-loaded lift closer to one another.

2. The method of claim 1, wherein the first and second ends of the fastener are configured to rotatably engage with the respective first and second locking elements, and wherein the method further comprising:
rotatably engaging the first end and the second end of the fastener with the respective first and second locking elements; and
rotating the fastener to compress the spring-loaded lift.

3. The method of claim 2, wherein the first and second locking elements each comprise a respective threaded male connector.

4. The method of claim 3, wherein:
the respective threaded male connector of the first locking element comprises a right-hand thread, and
the respective threaded male connector of the second locking element comprises a left-hand thread.

5. The method of claim 3, wherein:
the first end of the fastener comprises a first threaded female connector configured to receive the respective threaded male connector of the first locking element, and
the second end of the fastener comprises a second threaded female connector configured to receive the respective threaded male connector of the second locking element.

6. The method of claim 1, wherein actuating the fastener is configured to move the first and second frames of the spring-loaded lift closer to each other by between approximately 6 to 10 inches.

7. The method of claim 1, wherein actuating the fastener is configured to compress a spring of the spring-loaded lift.

8. The method of claim 7, the method further comprising:
de-actuating the fastener thereby moving the first and second frames of the spring-loaded lift away from one another and incrementally releasing the spring.

9. The method of claim 1, wherein the first and second frames each comprise a receptacle configured to respectively receive the first and second locking elements.

10. The method of claim 9, wherein:
the first and second locking elements each comprise a respective hook; and
the receptacle is configured to receive the respective hook.

11. The method of claim 1, wherein:
engaging the first locking element with the first frame of the spring-loaded lift comprises engaging a first bracket with the first frame and engaging the first locking element with the first bracket, and
engaging the second locking element with the second frame of the spring-loaded lift comprises engaging a second bracket with the second frame and engaging the second locking element with the second bracket.

12. A spring-loaded lift comprising:
a first frame comprising a first receptacle;
a second frame comprising a second receptacle; and
a coupling comprising a first locking element, a second locking element, and a fastener,
wherein the first locking element is configured to engage with the first frame via the first receptacle,
wherein the second locking element is configured to engage with the second frame via the second receptacle,
wherein a first end of the fastener is configured to engage with the first locking element,
wherein a second end of the fastener is configured to engage with the second locking element, and
wherein actuating the fastener thereby moves the first and second frames of the spring-loaded lift closer to one another.

13. The spring-loaded lift of claim 12, wherein the first and second ends of the fastener are configured to rotatably engage with the respective first and second locking elements.

14. The spring-loaded lift of claim 12, wherein the first and second locking elements each comprise a respective threaded male connector.

15. The spring-loaded lift of claim 14, wherein:
the first end of the fastener comprises a first threaded female connector configured to receive the respective threaded male connector of the first locking element, and
the second end of the fastener comprises a second threaded female connector configured to receive the respective threaded male connector of the second locking element.

16. The spring-loaded lift of claim 12, further comprising a first bracket and a second bracket.

17. The spring-loaded lift of claim 16, wherein:
the first locking element is configured to engage with the first bracket;
the first bracket is configured to removably engage with the first frame via the first receptacle;
the second locking element is configured to engage with the second bracket; and
the second bracket is configured to removably engage with the second frame via the second receptacle.

18. The spring-loaded lift of claim 12, wherein the coupling is configured to be stored on at least one of the first frame and the second frame when not in use.

19. The spring-loaded lift of claim 18, wherein at least one of the first locking element, the second locking element, and the fastener can be stored together or as separate elements.

20. A system comprising:
a U-boat utility cart comprising a platform;
a spring-loaded lift comprising:
a bottom frame configured to removably engage with the platform;
a first frame comprising a first receptacle; and
a second frame comprising a second receptacle; and
a coupling comprising a first locking element, a second locking element, and a fastener,
wherein the first locking element is configured to engage with the first frame via the first receptacle,
wherein the second locking element is configured to engage with the second frame via the second receptacle,
wherein a first end of the fastener is configured to engage with the first locking element,
wherein a second end of the fastener is configured to engage with the second locking element, and
wherein actuating the fastener thereby moves the first and second frames of the spring-loaded lift closer to one another.
